(19) United States
(12) Patent Application Publication
(10) Pub. No.: US 2014/0195363 A1
(43) Pub. Date: Jul. 10, 2014

(54) ELECTRONIC PAYMENT PROCESSING SYSTEM

(71) Applicants: Jason Andrew VAN, East Killara (AU); Adrian Xavier CLEEVE, Melbourne (AU)

(72) Inventors: Jason Andrew VAN, East Killara (AU); Adrian Xavier CLEEVE, Melbourne (AU)

(73) Assignee: TOUCH NETWORKS PTY LTD, Melbourne (AU)

(21) Appl. No.: 14/199,931

(22) Filed: Mar. 6, 2014

Related U.S. Application Data
(63) Continuation of application No. PCT/AU2012/001004, filed on Aug. 28, 2012.

(30) Foreign Application Priority Data
Sep. 2, 2011 (AU) 2011903567

(51) Int. Cl. G06Q 20/32; G06Q 20/40; G06Q 20/42; G06Q 20/20

(52) U.S. Cl. CPC G06Q 20/322; G06Q 20/202; G06Q 20/405; G06Q 20/42; G06Q 20/3224
USPC 705/21

(57) ABSTRACT

An electronic method of making a merchant payment comprising:

receiving user payment request data transmitted from a mobile device, the user payment request data comprising a payment amount and a merchant identifier;

checking a user record corresponding to the mobile device to determine based on at least one payment rule whether to generate merchant payment data corresponding to the payment amount of the user payment request data; and

upon generating merchant payment data, transmitting the merchant payment data to a point of sale (POS) terminal corresponding to the merchant identifier.

### CROSS-REFERENCE TO RELATED APPLICATIONS

This application is a continuation of PCT Application PCT/AU2012/001004, filed Aug. 28, 2012, and published under the PCT Articles in English as WO 2013/029095 A1 on Mar. 7, 2013. PCT/ AU2012/001004 claimed priority to Australian Application No. 2011903567, filed Sep. 2, 2011. The entire disclosures of PCT/AU2012/001004 and Australian Application No. 2011903567 are incorporated herein by reference in their entirety.

### FIELD

The present invention relates to an electronic method of making a merchant payment and an electronic payment processing system that enables a user to make a payment with a mobile device.

### BACKGROUND

Methods of paying merchants at the merchant's premises have evolved over time from customers paying with currency to the use of electronic payment systems such as EFTPOS (electronic funds transfer at point of sale).

More recently, systems have been developed that enable customers to make payments using their mobile phones, for example by registering with a payment service and subsequently using their phones to access the payment service to pay for a service such as a parking

Such systems have yet to find wide acceptance and accordingly, there is a need for methods and systems that enable alternative payment techniques.

### SUMMARY

In a first aspect, the invention provides an electronic method of making a merchant payment comprising:
receiving user payment request data transmitted from a mobile device, the user payment request data comprising a payment amount and a merchant identifier;
checking a user record corresponding to the mobile device to determine based on at least one payment rule whether to generate merchant payment data corresponding to the payment amount of the user payment request data; and
upon generating merchant payment data, transmitting the merchant payment data to a point of sale (POS) terminal corresponding to the merchant identifier.

In an embodiment, the method comprises transmitting a payment confirmation message to the mobile device upon generating merchant data.

In an embodiment, the user payment request further comprises a terminal identifier identifying one of a plurality of POS terminals of the merchant and the method comprises transmitting the merchant payment data to the identified POS terminal.

In an embodiment, the method comprises, upon generating merchant payment data, updating the user record to include a data entry corresponding to the payment amount, the record indicating an amount owing by the user to an entity responsible for settling the amount specified by the merchant payment.

In an embodiment, the method comprises, upon generating merchant payment data, updating a merchant record to include a data entry corresponding to the payment amount less a commission such that the data entry defines the amount owing to the merchant by the entity responsible for settling the amount specified by the merchant payment.

In an embodiment, the method comprises determining, responsive to receipt of the payment request, whether to communicate an offer to the mobile device.

In an embodiment, the method comprises determining, responsive to receipt of the payment request, whether to apply an offer to the payment request.

In an embodiment, the method comprises receiving location information transmitted from the mobile device and transmitting one or more merchant identifiers to the mobile device to enable the merchant identifier to be included in the payment request data transmitted from the mobile device.

In an embodiment, the method comprises transmitting at least two merchant identifiers to the mobile device and receiving a selection of one of the at least two merchant identifiers at the mobile device.

In an embodiment, the method comprises determining location information to be transmitted at the mobile device responsive to a user activating a payment module on the mobile device.

In an embodiment, the method comprises obtaining the location information with a GPS module of the mobile device.

In an embodiment, the method comprises obtaining the location information by performing a geolocation process at the mobile device.

In an embodiment, the method comprises a user manually entering a merchant identifier at the mobile device.

In a second aspect, the invention provides an electronic payment processing system arranged to:
receive user payment request data transmitted from a mobile device, the user payment request data comprising a payment amount and a merchant identifier;
check a user record corresponding to the mobile device to determine based on at least one payment rule whether to generate merchant payment data corresponding to the payment amount of the user payment request data; and
upon generating merchant payment data, transmit the merchant payment data to a point of sale (POS) terminal corresponding to the merchant identifier.

In an embodiment, the electronic payment processing system is arranged to transmit a payment confirmation message to the mobile device upon generating merchant data.

In an embodiment, the user payment request further comprises a terminal identifier identifying one of a plurality of POS terminals of the merchant and the electronic payment processing system is arranged to transmit the merchant payment data to the identified POS terminal.

In an embodiment, the electronic payment processing system is arranged to, upon generating merchant payment data, update the user record to include a data entry corresponding to the payment amount, the record indicating an amount owing by the user to an entity responsible for settling the amount specified by the merchant payment.

In an embodiment, the electronic payment processing system is arranged to, upon generating merchant payment data, update a merchant record to include a data entry corresponding to the payment amount less a commission such that the data entry defines the amount owing to the merchant by the entity responsible for settling the amount specified by the merchant payment.

In an embodiment, the electronic payment processing system is arranged to determine, responsive to receipt of the payment request, whether to communicate an offer to the mobile device.

In an embodiment, the electronic payment processing system is arranged to determine, responsive to receipt of the payment request, whether to apply an offer to the payment request.

In an embodiment, the electronic payment processing system is arranged to receive location information transmitted from a payment module of the mobile device and transmitting one or more merchant identifiers to the mobile device to enable the merchant identifier to be included in the payment request data transmitted from the mobile device.

In an embodiment, the electronic payment processing system is arranged to transmit at least two merchant identifiers to the payment module and receiving a selection of one of the at least two merchant identifiers from the payment module of the mobile device.

In an embodiment, the electronic payment processing system is arranged to determine location information to be transmitted at the mobile device responsive to a user activating the payment module on the mobile device.

In an embodiment, the electronic payment processing system is arranged to obtain the location information with a GPS module of the mobile device.

In an embodiment, the electronic payment processing system is arranged to obtain the location information by performing a geolocation process at the mobile device.

In an embodiment, the payment module causes a display of the module to display an input screen prompting a user to manually enter a merchant identifier at the mobile device.

In an embodiment, the electronic payment processing system comprises a first server arranged to receive the user payment and check the user record to determine whether merchant payment data should be generated and a second server in data communication with the first server and responsive to a determination from the first server that merchant payment data should be generated to transmit merchant payment data to the POS terminal.

The invention also provides computer program code which when executed implements the method described above and a tangible computer readable medium comprising the computer program code.

### BRIEF DESCRIPTION OF DRAWINGS

An exemplary embodiment of the invention will now be described with reference to the accompanying drawings in which:

FIG. 1 is a block diagram of a processing system for preferred embodiment;

FIG. 2 is a flow chart showing the method of an embodiment; and

FIGS. 3A to 3E are exemplary screen shots showing how the user makes a payment request in accordance with a preferred embodiment.

### DETAILED DESCRIPTION

Referring to the drawings, there is shown a payment processing system 10 that enables a method of making a merchant payment. In an embodiment a user operates their mobile device to input details of a payment request and that payment request is sent to a first server controlled by an entity who will make the payment on behalf of the user. The first server is part of a central payment processing system 200 that carries out the payments. If the payment is approved by the first server, a merchant payment is generated and sent to a point of sale terminal at the merchant's premises in order to complete the payment. In an advantageous embodiment, location information of the mobile device 100 is transmitted to the central payment processing system 200 to enable the central processing system 200 to provide the mobile device with details to enable selection of the merchant.

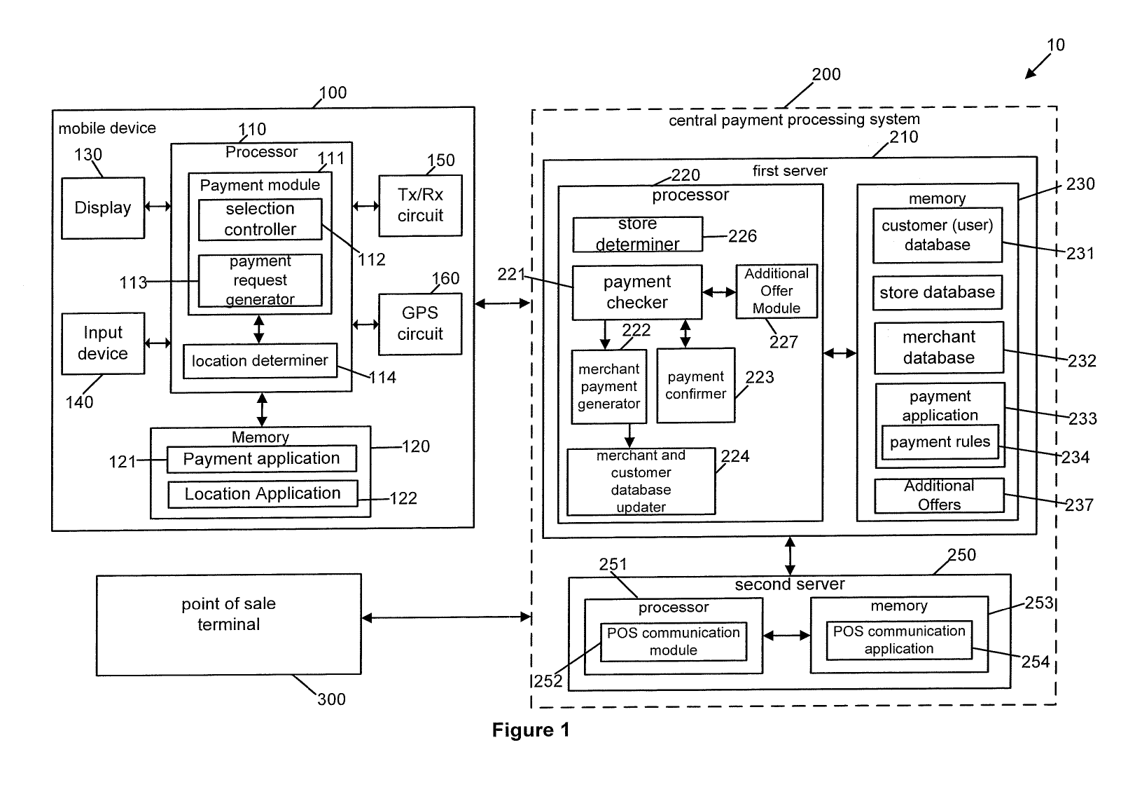

Referring to FIG. 1, there is shown a mobile device 100, such as a mobile phone that has a number of components including a processor 110, a memory 120 storing computer program applications 121, 122, a display 130, an input device 140, such as a keypad or a touch screen, a transmit and receive circuit 150 and a GPS (global positioning system) circuit 160. Such components are typically found in modern smart phones but are also present in other mobile devices such as tablet computers.

As is known in the art, the applications stored in memory 120 when run by the processor provide modules or implement specific functions on the processor. Persons skilled in the art will appreciate that in other embodiments, dedicated circuits could be provided to implement such modules. However, the advantage of using a processor and applications is that only relevant applications need to be run at any time such that multipurpose nature of the processor can be exploited.

As is currently common practice, some applications may be pre-loaded in the memory or be part of the operating system of the mobile device. FIG. 1 shows an example of a pre-loaded application in the form of location application 122 which instantiates a location determiner 114 that communicates with the electronics of the GPS monitoring circuit 160 to provide information about the mobile devices current location to the processor for use by other applications. For example, to report the current location to the user, for use in navigation tool etc.

As is also now common place, the mobile device 100 is arranged such that third party or subsequently developed applications can be downloaded and stored in the memory 120 of the mobile device. Here, a payment application 122 has been downloaded into the memory 122 which enables a payment module 111 to be instantiated by the processor. In the following description, it is assumed that the payment application 121 has already been downloaded onto the mobile device. This may require a registration process.

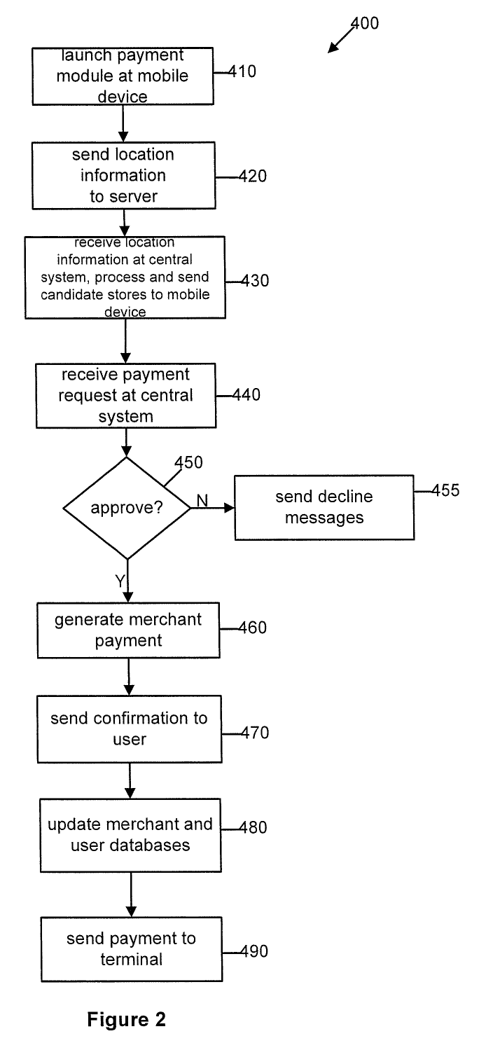

Referring to FIG. 2, when a user wishes to generate payment request data for approval and actioning by the central payment system 200, they launch 410 the payment module at the mobile device 100. This leads to the payment module 111 running on the processor 110. The payment module 111 is configured to transmit location information automatically to the central processing system 200 to enable the central processing system 200 to provide the payment module 111 with candidate merchant stores related to the user's current location.

In this respect, the payment module includes a selection controller 112 which communicates with the location determiner 114 to obtain the location information. The selection controller 112 transmits the location information to a first server 210 of the central payment processing system 200. Like the mobile device 100, the first server 210 has a number of modules instantiated by a processor 220 based on program code stored in a memory 230 specifically based on payment application 233. The payment application 233 includes program code which when executed by the processor causes a store determiner 226 to be instantiated. The store determiner queries store database 235 based on the coordinates provided from the global positioning circuit as forwarded by the selection controller 112. Depending on the location information, the store determiner 226 may return details of one or more stores to the selection controller 112.

The selection controller 112 may also be arranged to provide information to the store determiner 226 that controls the number of stores returned. For example, data indicative of the level of confidence that the user is at the current location. GPS circuits require a level of visibility to relevant satellites. This may not occur when the user is inside—for example in a large shopping mall. Accordingly, the location determiner 114 may pass to the selection controller 111 information regarding the last known location of the device 100 as the current location together with data indicating how long ago that location was determined to thereby allow the store determiner 226 to determine how many stores to return—for example, based on an estimated range of movement of the device 100 in the elapsed time period.

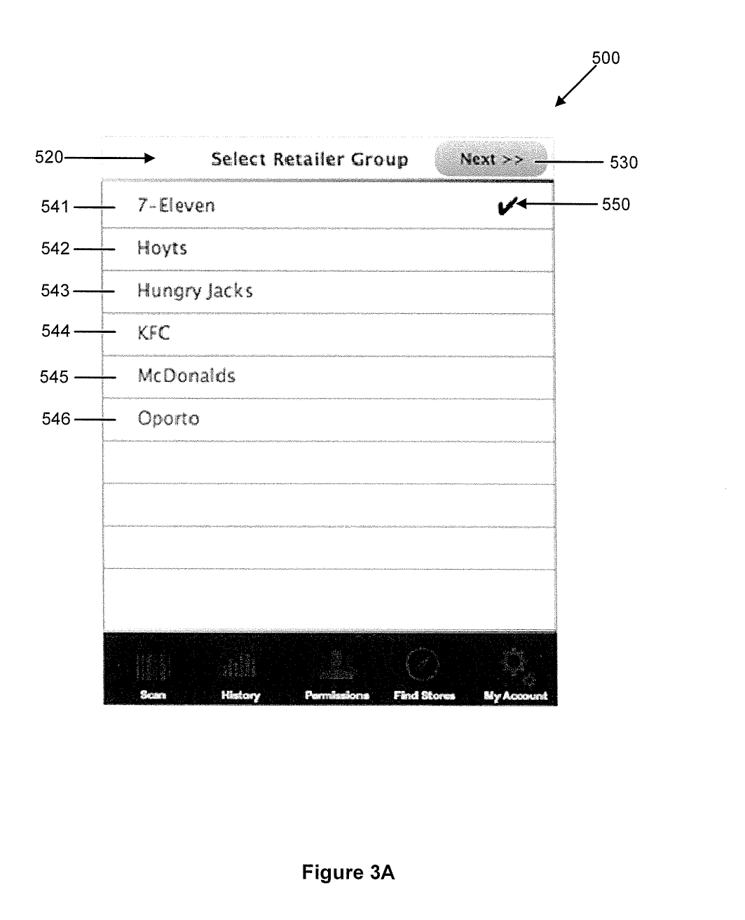

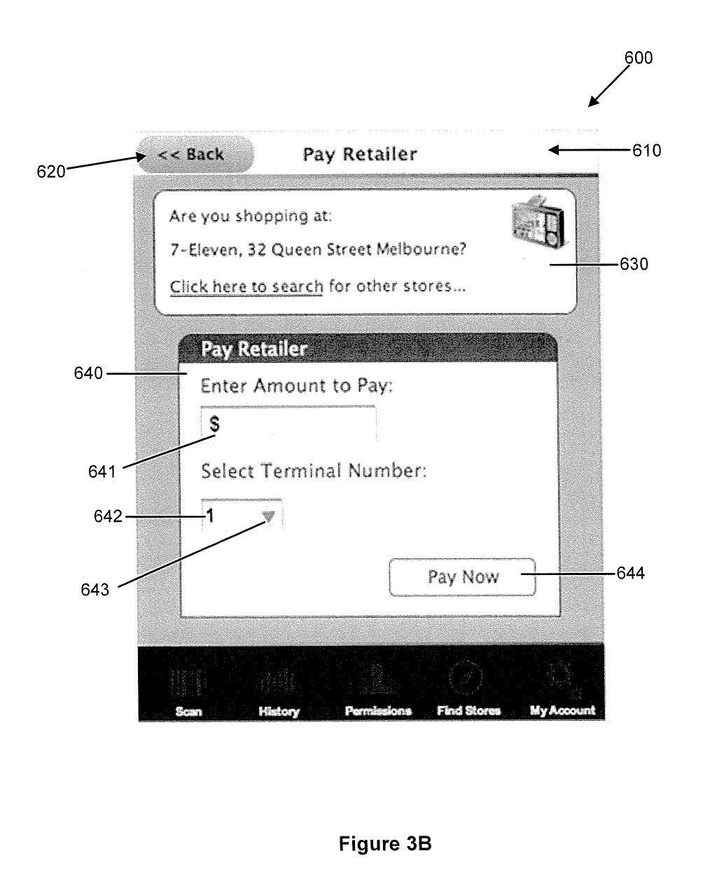

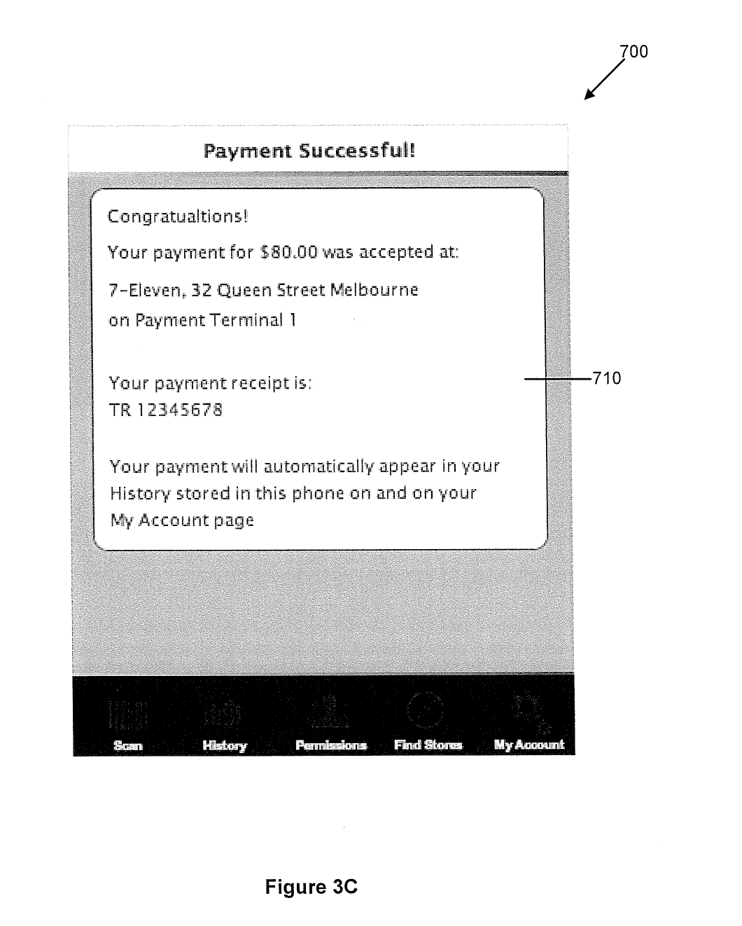

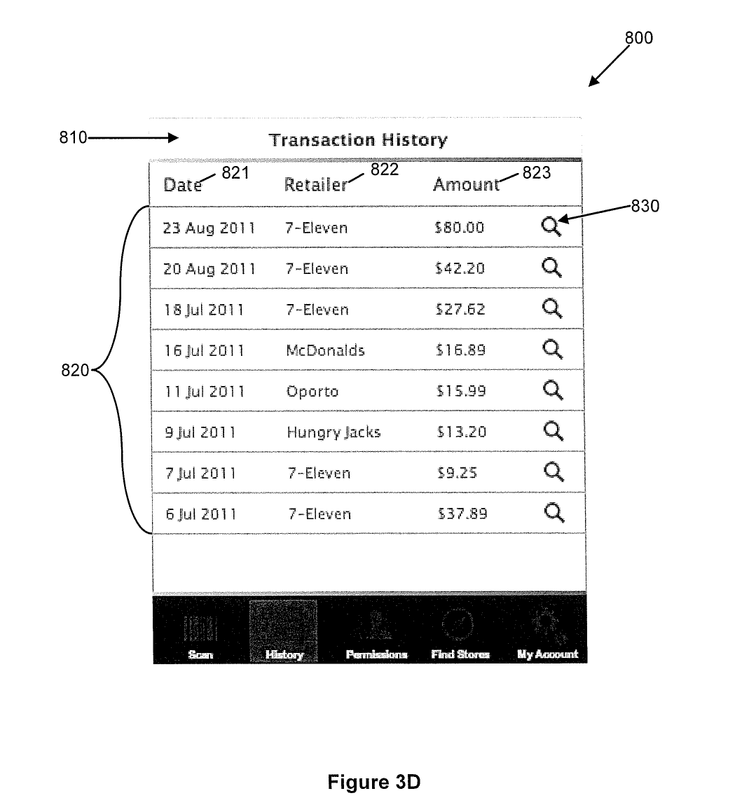

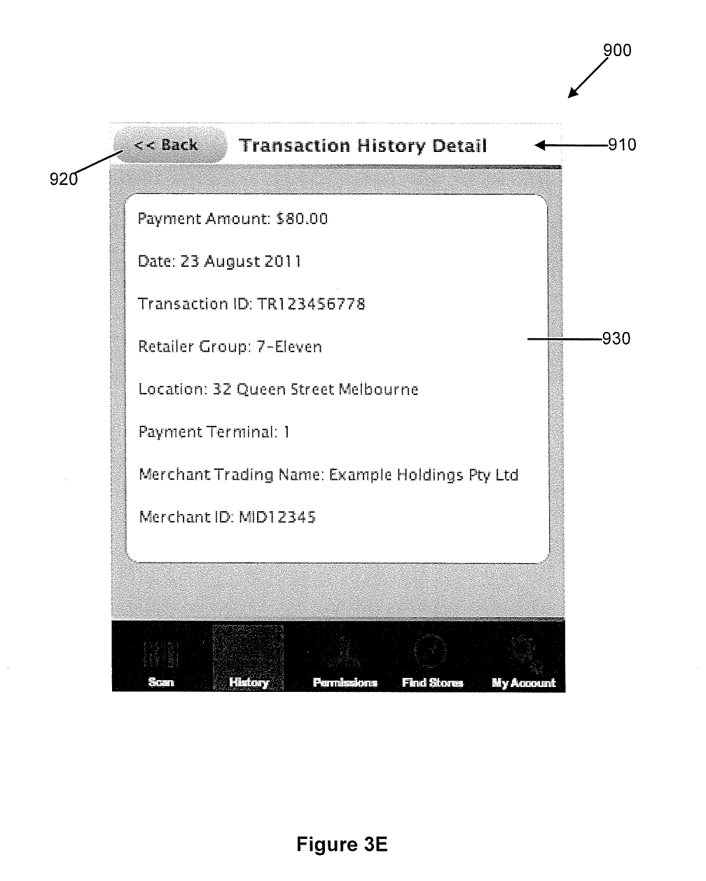

Selection controller 112 may also be arranged to request additional information from the user as shown for example in FIG. 3A to narrow the search to stores of particular type. In such an example, as will be described in further detail below, the user may operate the input device 140 based on a list of possible stores shown on display 130 to provide information that the selection controller 112 can provide to the store determiner 226 to narrow the search of the store database.

Location determiner 114, may allow for other techniques of locating a nearest location which may be used as a backup when the GPS information is not used. For example, the location determiner 114 may use geolocation to triangulate the position of the mobile phone based on the mobile phone towers which are closest to it. The selection controller 112 may be arranged to fall back on this information if GPS information is not available. The selection controller 112 may also be arranged such that there is no viable location information, it requests the user to manually enter a merchant identifier by displaying an input message on display 130 and receiving input via an input device. This may be required, for example, if the user's mobile phone has been turned off for a period of time and the user turns it on at a position where GPS data is not accessible.

Accordingly, irrespective of the approach followed to obtain information that can provided to the store determiner 226, the store determiner 226 ultimately returns to the selection controller 112, details of a determined merchant store or a list of merchant stores from which the user can select. This store or stores is displayed to the user on the display 130 and the user operates the input device to select the relevant store or reject it if the suggestion doesn't match the user's location. In addition, the user operates the input device 140 to input an amount to be paid for the current transaction—for example, $10. Depending on whether the merchant has more than one point of sale terminal, the user may also be prompted to enter via input device a terminal identifier which would be typically identified at the point of sale terminal by signage. The payment request generator aggregates the selected merchant, the terminal identifier, and the payment amount into payment request data and transmits this using TX/RX circuit 150 to the first server.

At this point, the payment checker 221 processes the payment request data to determine whether a merchant payment should be generated. The payment checker checks the payment based on one or more payment rules 234 which form part of the payment application 233. The payment rules are instantiated in program code which causes the payment checker 221 to perform one or more checks in respect of the record for the specific customer (user) in the customer database 231. Firstly, the payment checker 221 retrieves the relevant customer record using the mobile phone number of the mobile device 100. The payment checker 221 then may determine whether the payment request is compliant. For example, the payment may need to be within a specific size, the customer's account may need to be in good standing, an overall limit on the customer account not be exceeded etc. In some embodiments the payment checker 221 may also check the merchant database 232. For example, it may need to determine whether payments of a particular size are accepted by this particular merchant as payments of different sizes may apply depending on the merchant.

Assuming the payment is approved, merchant payment generator 222 generates merchant payment data identifying the merchant and the terminal and sends the merchant payment data to a second server 250 which is configured to communicate with the point of sale terminal 300. To this end, the processor 251 of second server 250 instantiates a point of sale communication module 252 which based on point of sale communication application 254 stored in memory 253. Persons skilled in the art will appreciate that in some embodiments there is no need for separate first and second servers. That is, all the function can be implemented on a single server. Persons skilled in the art will also appreciate that various of the above functions can be split over other servers.

The second server 250 takes the merchant payment request and formats it with the point of sale communication module 252 into a format which will be interpreted correctly by the point of sale terminal 300. The merchant payment is then sent to the point of sale terminal 300 to complete the transaction. Concurrently the payment confirmer 223 sends a message to the mobile device 100 confirming that the payment is being made.

Further, once the merchant payment has been generated, a merchant and customer database updater 224 updates the customer database including the record of the user that made the payment request to reflect that the customer now owes the entity an amount corresponding to the payment request. The updater 224 also updates merchant database 232 to include a record in the merchant record for the relevant merchant specifying the amount now owed to the merchant. Typically, this will show an amount owing to the merchant that corresponds to the payment amount less a commission for processing the payment owed to the entity controlling the first server 210 as a result of the transaction. That is, the entity controlling the first server 210 will redeem a commission in exchange for processing the transaction.

The method 400 of the embodiment is summarised in FIG. 2 which shows that the payment module is launched 410 on a mobile device which sends location information to first server 420. The method 400 then involves receiving 430 location information, processing it and sending candidate stores 430 to the mobile device 100. At the mobile device 100 a payment request is generated such that the payment request 430 is received at the central processing system 200. The payment checker 221 determines whether or not to approve the transaction. If it decides not to approve the transaction, decline messages are sent 455 to the mobile device and to the point of sale at the terminal respectively. Upon deciding 450 to approve the transaction, a merchant payment is generated 460. A confirmation message is sent to the user 470 and the central payment processing system 200 updates the merchant and user databases 480. The merchant payment is sent to the point of sale terminal 490 and the user is able to take the goods or services paid for and depart.

From the above description, it will be apparent that the merchant payment is not the same as the payment request. That is, the system does not merely take the payment request and pass it on via the second server to the point of sale terminal. Rather, the central payment processing server takes the active step of generating a merchant payment that originates from the controller of the first controlling entity of the first server for an amount corresponding to the amount specified in the original payment request.

The first server also has an additional offer module 227. When the payment request is received, it is passed to additional offer module 227. The additional offer module 227 is arranged to check the user record to determine whether an offer has already been provided to the user which the user is now entitled to redeem as part of the current transaction. This can result in the offer being applied during the current transaction, for example by applying a discount to the transaction or communicating additional information at the point of sale terminal such that the operator at the point of sale terminal can provide a promotional item to the user. In some embodiments, the offer module may communicate with the user via mobile device 110 to receive a confirmation that the user wishes to have the offer applied to the current transaction. For example, if the payment is a percentage discount on a fuel bill and the user has only put in a small amount of fuel, they may not wish to redeem the offer during the current transaction.

In other embodiments, the additional offer module may also determine based on additional offers 237 stored in memory 230 whether an additional offer should be made to the user to apply to the current or a future transaction. Upon making such a determination, additional offer module 227 updates the customer record in the user database. The payment confirmer 223 may be arranged to communicate details of the offer to the user.

### EXAMPLE

FIGS. 3A to 3E show exemplary mobile device screen shots 500, 600, 700, 800, 900 of one example. As shown in FIG. 3A, a user has launched an application on the mobile device and, in this example, the application prompts the user to select a retail group as part of the selection process. The instruction 520 to select a retailer group is shown at the top of the screen 500. Persons skilled in the art will appreciate that as part of the launching of the program, the user could also be required to confirm personal details, for example by entering a PIN.

As shown in this example, six potential retailers are available namely “7-Eleven” 541, “Hoyts” 542, “Hungry Jacks” 543, “KFC” 544, “McDonalds” 545 and “Oporto” 546. As indicated by arrow 550, the user has selected “7-Eleven” 541.

After the store determiner 226 has checked the store database 235 to determine a relevant store, in a second screen (which the user has transitioned to by pressing the next button 530 in the first screen shown in FIG. 3A) the user is presented with the option to pay a retailer 610. If the user has selected the wrong store type, they can return to the previous menu using back button 620. In screen 600, a store selection message 630 is displayed to the user. In this case, asking the user if they are at a “7-Eleven” store at a particular address. In other embodiments, the user may be presented option to select stores. For example, rather than using the store selection screen 500 shown in FIG. 3A, may be presented with a list of stores corresponding to those of different retailers in selection area 630 from FIG. 3B to enable the user to select their store.

In the example, it is assumed that the user has selected the correct store and accordingly they use a pay retailer box 640 to enter an amount to pay in payment area 641—for example $20. The user also selects a terminal in terminal number entry area 642 which contains a drop down list 643. In some embodiments, a set of viable terminal numbers may be sent to the user such that the available terminal numbers in drop down list 643 vary from case to case. In other embodiments, there may only be one valid terminal and hence no need for there to be a selection. Once the user has entered the details and selected the store (or confirmed that the store selected made for them by the selection controller 112 is correct) they press a pay now button 644. As shown in FIG. 3C, in a following screen 700, the user subsequently receives a payment message (transmitted, for example, by SMS) confirming that the payment is correct.

In addition to the above, the user may be able to access a transaction history screen 800 as indicated by the tile transaction history 810. A set of prior transactions 820 are displayed. The user can select the magnifying glass icon 830 beside any of the transactions to view the details of the specific transaction. This results in the user moving to a transaction history detail screen 900 as indicated by transaction history detail header 910 and view details 930 of the specific transaction. A back button 920 allows the user to return to the transaction history 800 shown in FIG. 3D.

Persons skilled in the art will appreciate that in accordance with known techniques, functionality at the server side of the network may be distributed over a plurality of different computers. For example, elements may be run as a single “engine” on one server or a separate server may be provided.

Further aspects of the method will be apparent from the above description of the system. It will be appreciated that at least part of the method will be implemented electronically, for example, digitally by a processor executing program code. In this respect, in the above description certain steps are described as being carried out by a processor, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electronic method of making a merchant payment comprising:
receiving user payment request data transmitted from a mobile device, the user payment request data comprising a payment amount and a merchant identifier;
checking a user record corresponding to the mobile device to determine based on at least one payment rule whether to generate merchant payment data corresponding to the payment amount of the user payment request data; and
upon generating merchant payment data, transmitting the merchant payment data to a point of sale (POS) terminal corresponding to the merchant identifier.

2. A method as claimed in claim 1, further comprising transmitting a payment confirmation message to the mobile device upon generating merchant data.

3. A method as claimed in claim 1, wherein the user payment request further comprises a terminal identifier identifying one of a plurality of POS terminals of the merchant and the method comprises transmitting the merchant payment data to the identified POS terminal.

4. A method as claimed in claim 1, comprising, upon generating merchant payment data, updating the user record to include a data entry corresponding to the payment amount, the record indicating an amount owing by the user to an entity responsible for settling the amount specified by the merchant payment.

5. A method as claimed in claim 4, comprising, upon generating merchant payment data, updating a merchant record to include a data entry corresponding to the payment amount less a commission such that the data entry defines the amount owing to the merchant by the entity responsible for settling the amount specified by the merchant payment.

6. A method as claimed in claim 1, comprising determining, responsive to receipt of the payment request, whether to communicate an offer to the mobile device.

7. A method as claimed in claim 1, comprising determining, responsive to receipt of the payment request, whether to apply an offer to the payment request.

8. A method as claimed in claim 1, comprising receiving location information transmitted from the mobile device and transmitting one or more merchant identifiers to the mobile device to enable the merchant identifier to be included in the payment request data transmitted from the mobile device.

9. A method as claimed in claim 8 comprising transmitting at least two merchant identifiers to the mobile device and receiving a selection of one of the at least two merchant identifiers at the mobile device.

10. A method as claimed in claim 8, comprising determining location information to be transmitted at the mobile device responsive to a user activating a payment module on the mobile device.

11. A method as claimed in claim 8, comprising obtaining the location information with a GPS module of the mobile device.

12. A method as claimed in claim 8, comprising obtaining the location information by performing a geolocation process at the mobile device.

13. A method as claimed in claim 1, comprising a user manually entering a merchant identifier at the mobile device.

14. An electronic payment processing system arranged to:
receive user payment request data transmitted from a mobile device, the user payment request data comprising a payment amount and a merchant identifier;
check a user record corresponding to the mobile device to determine based on at least one payment rule whether to generate merchant payment data corresponding to the payment amount of the user payment request data; and
upon generating merchant payment data, transmit the merchant payment data to a point of sale (POS) terminal corresponding to the merchant identifier.

15. An electronic payment processing system as claimed in claim 14, further arranged to transmit a payment confirmation message to the mobile device upon generating merchant data.

16. An electronic payment processing system as claimed in claim 14, wherein the user payment request further comprises a terminal identifier identifying one of a plurality of POS terminals of the merchant and the electronic payment processing system is arranged to transmit the merchant payment data to the identified POS terminal.

17. An electronic payment processing system as claimed in claim 14, arranged to, upon generating merchant payment data, update the user record to include a data entry corresponding to the payment amount, the record indicating an amount owing by the user to an entity responsible for settling the amount specified by the merchant payment.

18. An electronic payment processing system as claimed in claim 17, arranged to, upon generating merchant payment data, update a merchant record to include a data entry corresponding to the payment amount less a commission such that the data entry defines the amount owing to the merchant by the entity responsible for settling the amount specified by the merchant payment.

19. An electronic payment processing system as claimed in claim 14, arranged to determine, responsive to receipt of the payment request, whether to communicate an offer to the mobile device.

20. An electronic payment processing system as claimed in claim 14, arranged to determine, responsive to receipt of the payment request, whether to apply an offer to the payment request.

21. An electronic payment processing system as claimed in claim 14, arranged to receive location information transmitted from a payment module of the mobile device and transmitting one or more merchant identifiers to the mobile device to enable the merchant identifier to be included in the payment request data transmitted from the mobile device.

22. An electronic payment processing system as claimed in claim 21, arranged to transmit at least two merchant identifiers to the payment module and receiving a selection of one of the at least two merchant identifiers from the payment module of the mobile device.

23. An electronic payment processing system as claimed in claim 21, arranged to determine location information to be transmitted at the mobile device responsive to a user activating the payment module on the mobile device.

24. An electronic payment processing system as claimed in claim 21, arranged to obtain the location information with a GPS module of the mobile device.

25. An electronic payment processing system as claimed in claim 21, arranged to obtain the location information by performing a geolocation process at the mobile device.

26. An electronic payment processing system as claimed in claim 14, wherein the payment module causes a display of the module to display an input screen prompting a user to manually enter a merchant identifier at the mobile device.

27. An electronic payment processing system as claimed in claim 14, comprising a first server arranged to receive the user payment and check the user record to determine whether merchant payment data should be generated and a second server in data communication with the first server and responsive to a determination from the first server that merchant payment data should be generated to transmit merchant payment data to the POS terminal.

28. Computer program code which when executed implements the method of claim 1.

29. A tangible computer readable medium comprising the computer program code of claim 28.
